(19) United States
(12) Patent Application Publication
(10) Pub. No.: US 2018/0144339 A1
(43) Pub. Date: May 24, 2018

(54) System, method, and computer program product for facilitating financial transactions

(71) Applicant: Bridg Payment Solutions Ltd, Road Town, Tortola (VG)

(72) Inventor: Moussa Burhan Beidas, Dubai (AE)

(73) Assignee: Bridg Payment Solutions LTD, Road Town, Tortola (VG)

(21) Appl. No.: 15/568,027

(22) PCT Filed: Apr. 20, 2015
(86) PCT No.: PCT/IB15/52872

§ 371 Date: Oct. 20, 2017

(51) Int. Cl. G06Q 20/38; G06Q 20/10; G06Q 20/40; G06Q 20/32; G06Q 30/06; H04L 9/32; H04L 29/06; H04L 29/08

(52) U.S. Cl. CPC G06Q 20/3821; G06Q 20/102; G06Q 20/40; H04L 67/2814; G06Q 30/06; H04L 9/3213; H04L 63/0428; G06Q 20/3224

(57) ABSTRACT

A system, method, and computer program product for facilitating a financial transaction between a payer device and a payee device is disclosed. A transaction request is generated in response to an authorisation request for initiating the financial transaction. Subsequently, one or more network access parameters associated with at least the payer device and the payee device are determined and a transaction mode is selected based thereon whereby one of the devices in a transactional network is designated to route the transaction request to a payment network. Finally, the transaction request is transmitted to the payment network through the designated device.

### BACKGROUND

The present invention relates to financial transactions and more particularly, to system, method, and computer program product for facilitating a financial transaction.

Our society has evolved over centuries from barter to banknotes and more recently, from banknotes to plastic currency. It is now commonplace for merchants to accept financial payments through various modes such as credit cards, debit cards, and a host of other similar financial instruments such as loyalty program cards, stored-value cards, and promotional instruments such as coupons. As we transition into an increasingly cashless society, money continues to retain its essential significance as a medium of exchange; however, actual manifestation thereof continues to metamorphose into ever evolving forms.

With mobile devices becoming ubiquitous in our daily lives, mobile based payment systems have garnered huge interest from all stakeholders. The digital wallets stored on mobile devices not only alleviate the problems associated with lugging around various possible forms of financial instruments but also offer several potential opportunities to enhance security and thereby, reduce fraudulent transactions. As such, mobile based payment systems appear to hold the potential to revolutionize the manner in which financial transactions are executed. Quite unsurprisingly, mobile based payment systems have become an intensive area of research and development.

Successful adoption of mobile based payment systems will, however, not be achieved without overcoming several challenges. Various stakeholders associated with the payment cards industry have placed considerable emphasis on the need for implementing security standards to minimize fraudulent transactions. While addressing security concerns is undeniably a fundamental pre-requisite for ensuring successful adoption of mobile based payment systems, several other key challenges will also need to be addressed.

One of the key challenges in ensuring widespread adoption of mobile based payment systems especially, in the context of under-developed and developing countries that lack sufficient communication infrastructure, is to address connectivity issues.

It is well recognised in the industry that for many years in the next decade or so, market penetration of smartphones will continue to be far greater than the customer base with subscription to data connection provided by telecom service providers. In other words, a significant number of smartphone users will lack data connectivity on their smartphones, principally relying on access to public or private wireless local area networks to avail of data connectivity based features and functionality of those smartphones. As mobile based payment systems mandate mobile data connectivity on the smartphone, a significant population of smartphone users will thus be deprived of the benefits that the mobile based payment systems have to offer.

It is also to be appreciated that several small retail outlets such as mom-and-pop stores omnipresent especially in various developing and under-developed countries may not have the necessary infrastructure to process mobile based payments.

Moreover, it is to be appreciated that the mobile based payment systems are desired to cater to not only in-store transactions at brick-and-mortal retail outlets but also, transactions between a merchant and a customer on-the-go. Such scenarios may include, for example, delivery of goods and services to a customer's location and so on.

In light of the foregoing, there is a need for such system and method for facilitating financial transactions that are adapted to operate under various possible scenarios in respect of mobile data connectivity on customer (payer) and merchant (payee) devices.

### SUMMARY

It is an object of the present invention to provide system, method, and computer program product for facilitating a financial transaction between a payer device and a payee device under different possible scenarios in respect of data connectivity on respective devices.

The object is achieved by providing a method, a system, and a computer program product for facilitating a financial transaction according to claims 1, 11, and 21 respectively. Further embodiments of the present invention are addressed in the dependent claims.

The underlying concept of the present invention is to enable a payer device and a payee device establish a short-range communication channel therebetween, generate a transaction request to effect transfer of funds from a financial account linked to the payer device to a financial account linked to the payee device in exchange for goods and/or services delivered from the payee entity (merchant) to the payer entity (customer), and designating one of the payer device and the payee device to transmit the transaction request to a payment network. The device selection involves determining network access parameters corresponding to the payer device and the payee device, which are required to engage in a financial transaction and dynamically selecting one of the devices based on various network access parameters. In effect, the device which provides more time and cost efficient access to the payment network is selected for transmitting the transaction request.

According to further technical features of the present invention, when neither the payer device nor the payee device has requisite data connectivity to be able to transmit the transaction request to the payment network, spatial regions in vicinity of the payer device and the payee device are scanned to identify one or more other devices which may act as a proxy that is, which may receive the transaction request over a short-range communication channel and subsequently, transmit the transaction request to the payment network. If such device in vicinity accepts to act as a proxy, the transaction request is routed through such device to the payment network.

According to still further technical features of the present invention, when neither the payer device nor the payee device has requisite data connectivity to be able to transmit the transaction request to the payment network, the financial transaction is performed in an offline mode wherein the transaction request is stored in both the payer device and the payee device. The offline mode may be opted for directly after neither of the payer device and the payee device is found to be capable of transmitting the transaction request to the payment network. Alternatively, the offline mode may be opted after attempts to identify a proxy device to route the transaction request are unsuccessful. In case the financial transaction is carried out in the offline mode, whichever of the payer device and the payee device acquires access to the payment network transmits the transaction request thereto. The payment network suitably processes the transaction request. Subsequently, when the other device also gains access to the payment network, the latter, either directly or in response to a transaction request send thereto, notifies such other device regarding completion of processing of the transaction request.

In a first aspect of the present invention, a method for facilitating a financial transaction in a transactional network is provided. The transactional network comprises at least a payer device and a payee device. Each device in the transactional network is communicatively interconnected. The payer device and the payee device are associated with a payer financial account and a payee financial account through a payer digital token and a payee digital token respectively. The transactional network is adapted for interfacing with a payment network. The payment network is adapted for executing a fund transfer from a payer financial account to a payee financial account. According to the method of the present invention, at a first step, a transaction request is generated in response to an authorisation request for initiating the financial transaction. Subsequently, one or more network access parameters associated with at least the payer device and the payee device are determined. The network access parameters provide information related to access to the payment network through the payer and payee devices. Thereafter, a transaction mode is set to one selected from a set of predefined transaction modes based on at least the network access parameters. Each predefined transaction mode designates at least one device in the transactional network to route the transaction request from the transactional network to the payment network. Finally, the transaction request is transmitted to the payment network through the designated device.

In a second aspect of the present invention, a system for facilitating a financial transaction in a transactional network is provided. The transactional network comprises at least a payer device and a payee device. Each device in the transactional network is communicatively interconnected. The payer device and the payee device are associated with a payer financial account and a payee financial account through a payer digital token and a payee digital token respectively. The transactional network is adapted for interfacing with a payment network. The payment network, in turn, is adapted for executing a fund transfer from a payer financial account to a payee financial account. The system comprises a transaction module, a first network interface module, a processing module, and a second network interface module. The transaction module is configured for generating a transaction request in response to an authorisation request for initiating the financial transaction. The first network interface module is configured for determining one or more network access parameters associated with at least the payer device and the payee device. The network access parameters provide information related to access to the payment network through the payer and payee devices. The processing module is configured for setting a transaction mode to one selected from a set of predefined transaction modes based on at least the network access parameters. Each predefined transaction mode designates at least one device in the transactional network to route the transaction request from the transactional network to the payment network. The second network interface module is configured for transmitting the transaction request to the payment network through the designated device.

In a third aspect of the present invention, a computer program product is provided. The computer program product is embodied on a non-transitory computer readable medium. The computer-readable medium comprises computer-executable instructions executable by a processor for facilitating a financial transaction in a transactional network in accordance with the first and the second aspects of the present invention.

Accordingly, the present invention provides a system, a method, and a computer program product for facilitating a financial transaction. Various additional technical features of the present invention are described in more detail in the detailed description provided later.

The techniques of the present invention offer several advantages.

First and foremost, the present invention ensures that a mobile based payment transaction is successfully executed under various possible scenarios in respect of data connectivity available on the payer and payee devices participating in the financial transaction.

When data connectivity is available on both devices, one of the devices is selected based on time and cost considerations to execute the transactions in minimum possible time while incurring minimum possible data charges. It is not necessary for both the payer device and the payee device to have data connectivity. When data connectivity is available on only one of the devices, that device is selected to transmit the transaction request to the payment network. In case, none of the two devices has data connectivity, the techniques of the present invention permit a user device in the vicinity to act as a proxy to route the transaction request to the payment network. Additionally or alternatively, the financial transaction may be undertaken in an offline mode.

As will be evident, the present invention therefore enables execution of financial transaction under all possible scenarios in respect of data connectivity on the two devices engaged in a financial transaction. It will be readily apparent from the description provided herein that the present invention will greatly facilitate adoption of mobile based payment systems in general and more particularly, in various under-developed and developing countries where the desired communication infrastructure is not yet available or even if available, corresponding costs are prohibitive, which in turn results in unavailability of data connectivity on several portable communication devices such as smartphones.

### BRIEF DESCRIPTION OF FIGURES

The present invention is further described hereinafter with reference to illustrated embodiments shown in the accompanying drawings, in which:

FIG. 1 illustrates a schematic view of a financial transaction network within which various techniques of the present invention are implemented in accordance with an embodiment of the present invention,

FIG. 2 illustrates a schematic view of a financial transaction system in accordance with an embodiment of the present invention,

FIG. 3 illustrates a schematic view of a financial transaction system in accordance with an alternative embodiment of the present invention,

FIG. 4 illustrates a flow-chart depicting a method for facilitating financial transactions in accordance with an embodiment of the present invention,

FIG. 5 illustrates a flow-chart depicting a method for facilitating financial transactions in accordance with an alternative embodiment of the present invention, and

FIG. 6 illustrates a sequence diagram depicting a method for facilitating financial transactions in accordance with an embodiment of the present invention.

### DETAILED DESCRIPTION OF PRESENT INVENTION

Various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

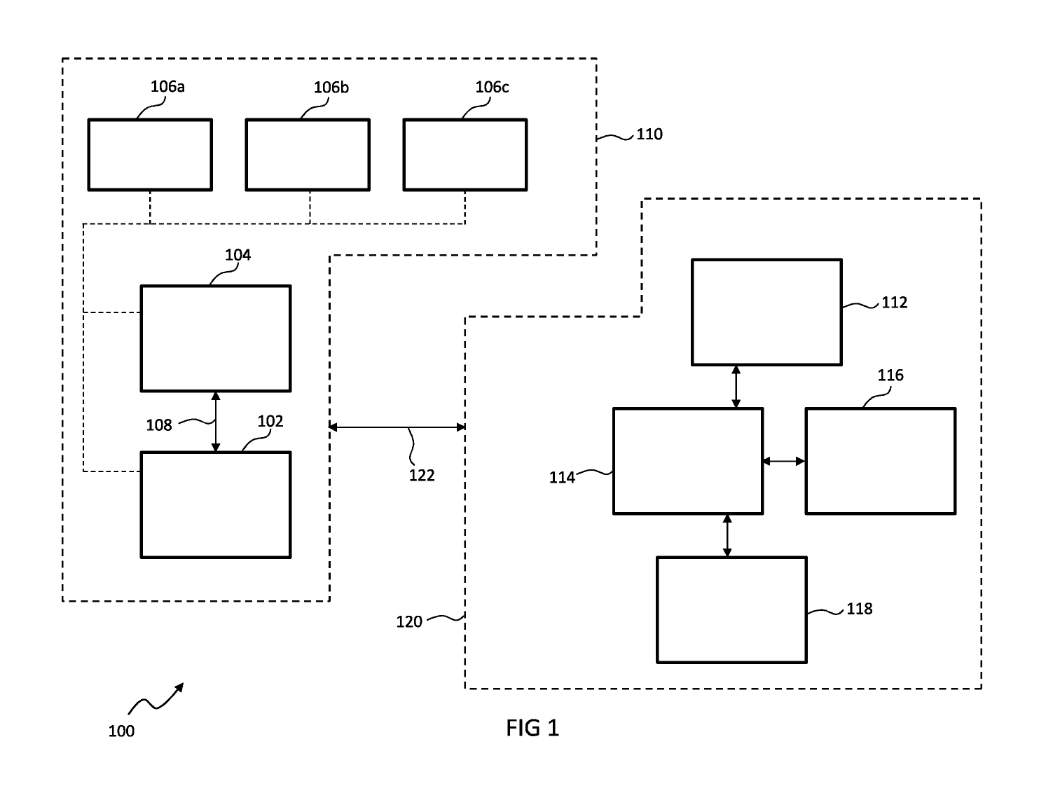

Referring to FIG. 1, a schematic view of a financial transaction network 100 within which various teachings of the present invention may be practiced is depicted.

The financial transaction network 100 includes a transactional network 110 and a payment network 120. The transactional network 110 and the payment network 120 are communicatively interconnection through communication channel 122. The communication channel 122 is implemented using any suitable communication network such as the Internet. The payer device 102 and/or the payee device 104 may connect to the payment network 120 through an internet service provider. In case data access through mobile network technologies such as GPRS, Edge, 2G, 3G, 4G, and the like is used, such communication channel 122 further includes a mobile network gateway.

The transactional network 110 includes a payer device 102, a payee device 104, and optionally, one or more proxy devices 106. In various exemplary embodiments of the present invention, the payer device 102, the payee device 104, and the proxy devices 106 are essentially similar devices. In one example, all of these devices 102 through 106 are handheld and/or portable communication devices that are configured according to the techniques of the present invention. In one example, each of the payer device 102 and the proxy devices 106 are mobile phones owned by individual users present at a merchant location such as a retail store. In various exemplary embodiments of the present invention, the devices 102 through 106 are named differently primarily to denote their respective roles in the context of a financial transaction. However, in an exemplary embodiment of the present invention, the devices 102 through 106 are similar in terms of their functionalities and features, and may be used interchangeably. Thus, a first portable communication device which is a payer device 102 and a second portable communication device which is a proxy device in one transaction may switch their roles in another transaction, such that the second portable communication device becomes the payer device 102 and the first portable communication device becomes the proxy device 106.

Various devices in the transactional network 110 are communicatively interconnected through communication channel 108 to enable data transfer therebetween. In various embodiments of the present invention, the devices 102 through 106 are communicatively interconnected through any suitable short-range communication protocol.

The payment network 120 includes an acquirer bank 112, a payment processor 114, token service provider 116, and an issuer bank 118. Various entities forming the payment network 120 are communicatively interconnected to enable data transfer therebetween.

In a typical financial transaction between two entities such as a merchant and a customer, one entity pays money to the other entity in exchange of goods and/or services. In the context of fund transfer, one party such as the customer becomes the ‘payer’ while the other party such as the merchant becomes the ‘payee’. However, such financial transactions may occur for a variety of reasons such as transfer of funds between family members and friends in a so-called peer-to-peer financial transaction.

The present invention will hereinafter be generally described with reference to ‘payer’ and ‘payee’, and while these terms will be used interchangeably with terms ‘customer’ and ‘merchants’ respectively, the techniques of the present invention are not limited to financial transactions occurring in a merchant-customer context and may be applied in any scenario that involves fund transfer between any two entities.

The techniques of the present invention are in general applicable to a financial transaction between any two entities that hold respective financial accounts with any suitable financial institutes such as a bank and the respective devices are linked to the respective financial accounts through unique digital tokens.

In accordance with teachings of the present invention, the payer device 102 and the payee device 104 are associated with a payer financial account and a payee financial account through a payer digital token and a payee digital token respectively.

In a typical scenario, the payer financial account corresponds to a credit card account administered by an issuer bank 118, while the payee financial account corresponds to a merchant account managed by an acquirer bank 112.

A credit card issued by the issuer bank 118 includes a primary account number (PAN) and certain other details such expiry date and security code (CVV). In one exemplary embodiment of the present invention, the details of the credit card required to undertake a financial transaction are bundled into the payer digital token. To obviate direct use of the primary account number and hence, eliminate or at least minimise fraudulent transactions, the token service provider 116 issues a digital token corresponding to the primary account number of the credit card. In this context, the digital token is also known as a ‘payment token’. As per EMV Payment Tokenisation Specification—Technical Framework v1.0 released by EMVCo LLC, a payment token is defined as following “payment tokens can take on a variety of formats across the payments industry. For this specification, the term Payment Token refers to a surrogate value for a primary account number that is a 13 to 19-digit numeric value that must pass basic validation rules of an account number, including the Luhn check digit. Payment Tokens are generated within a BIN range that has been designated as a Token BIN Range and flagged accordingly in all appropriate BIN tables. Payment Tokens must not have the same value as or conflict with a real PAN.” The token service provider 116 maintains a so-called token vault with mapping between the primary account number and the digital token.

A merchant account set up by the acquirer bank 112 for the merchant is typically identified using a unique identity, which is referred to as merchant identity or card acceptor identity. The acquirer bank 112 is responsible for managing the merchant identity and also, for maintaining details of a banking account linked to the merchant identity such that fund transfer from a customer financial account with the issuer bank 118 to a merchant financial account with the acquirer bank 112 may be completed.

As will be evident from above, in essence, both the merchant and the customer are assigned unique identities/credentials that are in turn linked to respective financial accounts. In the description provided herein the term “digital token” has been used generically to refer to such identity data and is not intended to be interpreted in the narrow sense of being referring only to a digital token corresponding to a credit card as provided by the token service provider 116.

In various exemplary implementations of the present invention, the payer device 102 is any suitable portable communication device such as mobile phone, tablet, personal digital assistant, netbook, laptop, palm-top and so on. The payee device 104 may be any portable communication device, which in turn forms a part of the merchant billing terminal and therefore, may work in conjunction with a bar-code scanning device. In other examples, the scanning functionality may be in-built within the payee device 104 of the present invention. Several other billing and/or accounting and/or inventory management related functionalities may also be integrated into the payee device 104. Each proxy device 106 may also be any suitable portable communication device similar to the payer device 102.

The payer device 102 and the payee device 104 store the respective digital tokens therein. In addition, the payer device 102, and optionally, also the payee device 104 may store encryption keys. In various examples, such encryption keys could be based on symmetric or asymmetric encryption techniques. The corresponding decryption keys are provided to relevant entities within the payment network 120. The essential objective behind using encryption techniques is to be able to authenticate the origin of a transaction request transmitted from the transactional network 110 to the payment network 120.

With a view to explain the techniques of the present invention in a simple manner, a typical in-store transaction scenario is now considered. It should be noted that this scenario is being discussed merely to facilitate understanding of the techniques of the present invention rather than limit the present invention in any manner.

A customer equipped with a payer device 102 visits a merchant store to purchase certain goods and/or services. The customer selects the desired goods and/or services. Using a point-of-sale terminal, the merchant then enters a financial value of goods and/or services desired to be purchased by the customer. The value of goods and/or services may be directly entered by the merchant or may be determined based on reading bar codes on labels on the goods being sold. The scanning module used to read the bar codes may be integrated into the payee device 104 or may be implemented as a separate unit operatively connected to the payee device 104.

In order to execute a financial transaction, the customer and the merchant establish a communication channel between the payer device 102 and the payee device 104. In various exemplary embodiments, such communication channel may be established using any suitable short-range communication protocols such as Bluetooth, Bluetooth Low Energy (BLE), Near-Field Communication (NFC), Wireless LAN, and so on. It is also possible to use a combination of protocols to establish a desired communication channel between the payer device 102 and the payee device 104. In various exemplary embodiments of the present invention, the payer device 102 and the payee device 104 may establish the communication channel 108 using a first short-range communication protocol such as NFC and then, switch to a second short-range communication protocol such as BLE.

Using the payee device 104, the merchant then sends an authorisation request to the payer device 102. The payer device 102 generates a prompt for approval of the authorisation request by the customer. Upon receiving customer's approval, the payer device 102 communicates the payer digital token to the payee device 104. The payee device 104 then generates the transaction request. In one exemplary embodiment of the present invention, in addition to the payer digital token and the payee digital token, the transaction request also includes such additional data such as a counter, time of transaction, device identity such as International Mobile Station Equipment Identity (IMEI), location information and the like that helps to ensure that any particular transaction request generated in the transactional network 110 is unique.

As will be appreciated, several variations are possible in respect of generation of the transaction request by the combination of the payer device 102 and the payee device 104 and either of the two devices 102, 104 may generate the transaction request provided the other device transfers its corresponding digital token along with any such additional data that is required to generate the transaction request. All such variations are well within the scope of the present invention.

Subsequent to generation of the transaction request, each of the payer device 102 and the payee device 104 evaluates network access parameters of the individual devices and negotiate to designate one device to transmit the transaction request to the payment network 120. The information related to corresponding network access parameters may be exchanged over the communication channel 108.

According to a particularly advantageous technical feature of the present invention, when neither the payer device 102 nor the payee device 104 has required data connectivity to transmit the transaction request to the payment network 120, the payer device 102 and/or the payee device 104 scan a spatial region in respective vicinities to identify one or more proxy devices 106. If one or more proxy devices 106 are available, one of the payer device 102 and the payee device 104 sends a routing request to the proxy device 106. In various exemplary embodiments of the present invention, a user of the proxy device 106 is prompted to provide an approval for such routing request. The user of the proxy device 106 may approve or reject the request. If approved, one of the payer device 102 and the payee device 104 transmits the transaction request to the proxy device 106, over communication channel 108, which in turn transmits it to the payment network 120 over the communication channel 122. If, however, the routing request is rejected, one of devices 102, 104 sends a routing request to another proxy device 106 available in the vicinity. The process of sending routing requests is repeated with the one or more proxy devices 106 present in the transactional network 110 until one of the proxy devices 106 approves the routing request or all proxy devices 106 have been already been sent the request.

In one exemplary embodiment of the present invention, the proxy device 106 may be configured to provide an approval for a routing request without prompting a user. The transaction request involves minimum data and the entire process, which involves transmitting transaction request to payment network 120, receiving transaction approval from payment network 120, and transmitting the transaction approval back to the requesting payer/payee device 102, 104 is completed in a fairly short time interval of about five seconds. Thus, users of the proxy devices 106 may select to configure their proxy devices 106 in such manner without worrying about any computational processing and/or data transfer cost related overheads.

In the event that neither the payer device 102 nor the payee device 104 has data connectivity, and no proxy device 106 is available to route the transaction request to the payment network 120, the payer device 102 and the payee device 104 may complete the financial transaction in an offline mode. When a financial transaction is completed in such mode, each device 102, 104 stores the transaction request therein. When these devices subsequently acquire access to the payment network 120, the transaction request is transmitted thereto. Each transaction request, generated using the techniques of the present invention, is unique. Therefore, the transaction request is submitted to payment network 120 in the first instance, by say, the payer device 102, the transaction request is processed in a routine manner. Subsequently, when the other device, the payee device 104 in this example, submits the transaction request stored therein, the payment network 120, after initial processing, sends a notification in a predefined format to inform the payee device 104 that transaction request has already been processed based on transaction request received from the payer device 102. The data records at the payee device 104 are updated accordingly.

Within the payment network 120, the transaction request is received by the payment processor 114 or the acquirer bank 112, the transaction request is then processed in a suitable manner by various entities in the payment network 120. In particular, based on payer digital token included in the transaction request, the issuer bank 118 approves or rejects the financial transaction depending on the status of the payer financial account. If approved, the corresponding funds are subsequently transferred to the merchant account managed by the acquirer bank 112, usually as part of a batch settlement process that is separately triggered afterwards.

The entities operating within the payment network 120 are well understood in the art and are only incidental to the teachings of present invention. As such, these entities are not being described in detail. It should be noted that the scope of the present invention is independent of and not limited by the actual steps performed within the payment network 120 and/or the entities involved in performing those steps. It should also be noted that credit card associations, payment processors, financial institutions and various other stakeholders are making concerted efforts to further enhance and improve the manner in which a transaction request is processed in the payment network 120. The techniques of the present invention are independent of any such modifications/improvements in the payment network 120 that may be implemented in future.

Having now explained the broad principles of present invention with reference to the financial transaction network 100, further technical features of the present invention will now be explained in more detail.

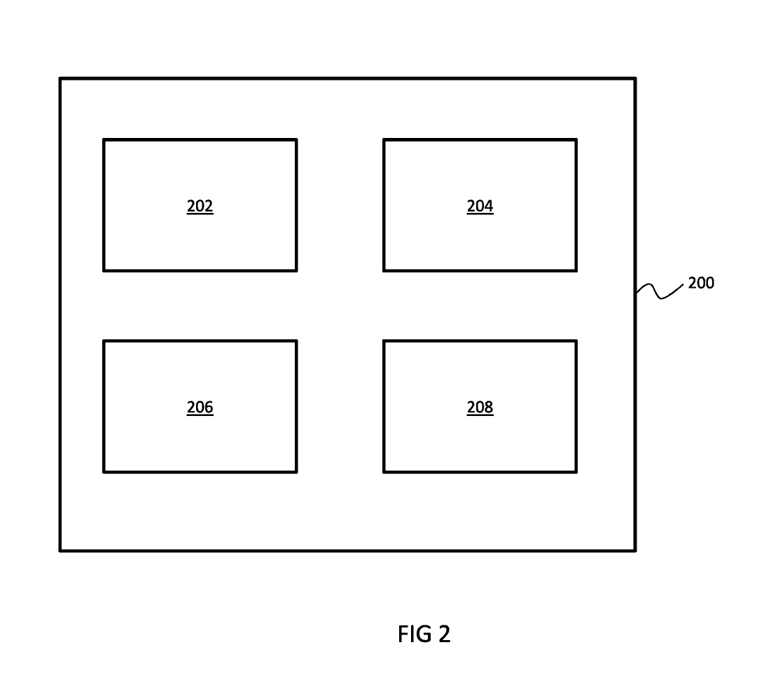

Referring now to FIG. 2, a schematic view of a financial transaction system 200 is depicted in accordance with an embodiment of the present invention.

The financial transaction system 200 includes a transaction module 202, a first network interface module 204, a processing module 206, and a second network interface module 208.

It should be noted that various modules 202 through 208 in the financial transaction system 200 are logical modules and may be implemented using software, hardware, firmware, or any combination thereof.

The financial transaction system 200 is configured for facilitating a financial transaction in the transactional network 110 and thus, in the financial transaction network 100. As explained in conjunction with the preceding description, the transactional network 110 includes at least the payer device 102 and the payee device 104. In addition, one or more proxy devices 106 may also be present. In essence, each of the devices in the transactional network 110 may have similar form factor in the sense that all such devices may be portable and/or hand-held devices so long as each of these devices in the transactional network 110 includes all four logical modules 202 through 208.

At least the payer device 102 and the payee device 104 are associated with a payer financial account and a payee financial account through a payer digital token and a payee digital token respectively.

Various devices 102 through 106 are capable of being communicatively interconnected to each other. As previously explained, in various embodiments of the present invention, the communication channel 108 is established using a short-range communication protocol or a combination of multiple such protocols.

The transactional network 110 is adapted for interfacing with the payment network 120 through communication channel 122. The payment network 120, in turn, is adapted for executing a fund transfer from a payer financial account to a payee financial account.

The transaction module 202 is configured for generating a transaction request in response to an authorisation request for initiating a financial transaction.

In an exemplary scenario, the authorisation request is generated by the payee device 104 and transmitted to the payer device 102 over the communication channel 108. The payer device 102 may then prompt a user to approve the authorisation request. Upon approval, the approved authorisation request is provided to the transaction module 202. The transaction module 202 of the payer device 102 transmit payer digital token along with additional data such as a cryptogram to the payee device 104 through the communication channel 108. The transaction module 202 at the payee device 104 then creates a transaction request. The communication over the communication channel 108 is enabled through first network interface modules 204 on the payer device 102 and the payee device 104.

The first network interface module 204 in principle helps to establish the communication channel 108 between individual devices 102, 104, and optionally 106 in the transactional network 110 through any suitable short-range communication protocol or combination of multiple such protocols. For example, the payer device 102 and the payee device 104 may initially interconnect through near-field communication (NFC) protocol and subsequently, switch to communication over Bluetooth or Bluetooth Low Energy (BLE).

The first network interface module 204 is also configured for determining one or more network access parameters associated with at least the payer device 102 and the payee device 104. The network access parameters provide information related to access to the payment network through the payer device 102 and the payee device 104. Such network access parameters include nature of connectivity such as mobile data connection such as GPRS, WAP, Edge, 3G, 4G etc or Ethernet and so on, bandwidth, data charges, and so. The key information intended to be captured using the network access parameters is whether a data connection is available or not, and if available, connection speed/bandwidth and data transfer costs.

The processing module 206 is configured for setting a transaction mode to one selected from a set of predefined transaction modes based on at least the network access parameters. In various exemplary embodiments of the present invention, suitable preference logic is encoded within the processing module 206 for selecting a transaction mode. Each predefined transaction mode essentially designates at least one device in the transactional network 110 to route the transaction request from the transactional network 110 to the payment network 120.

The desired transaction mode is selected based on preference criterion in respect of the network access parameters. For example, between broadband/Ethernet connection and a 3G connection, the broadband/Ethernet connection is given preference and so on. In an exemplary embodiment of the present invention, the preference criterion is primarily based on data transfer speed and cost considerations but may generally be configured to be based on any desired parameters.

The second network interface module 208 is configured for transmitting the transaction request to the payment network 120 through the designated device.

It will be readily apparent that several variations are possible in terms of data flows between the devices 102, 104 in the transactional network 110. For example, instead of sending the payer digital token to the payee device 104, the payer device 102 may request for payee digital token and any other required information and itself generate the transaction request. All such variations are intended to be included within the scope of the present invention. Some additional technical features of the present invention will now be explained.

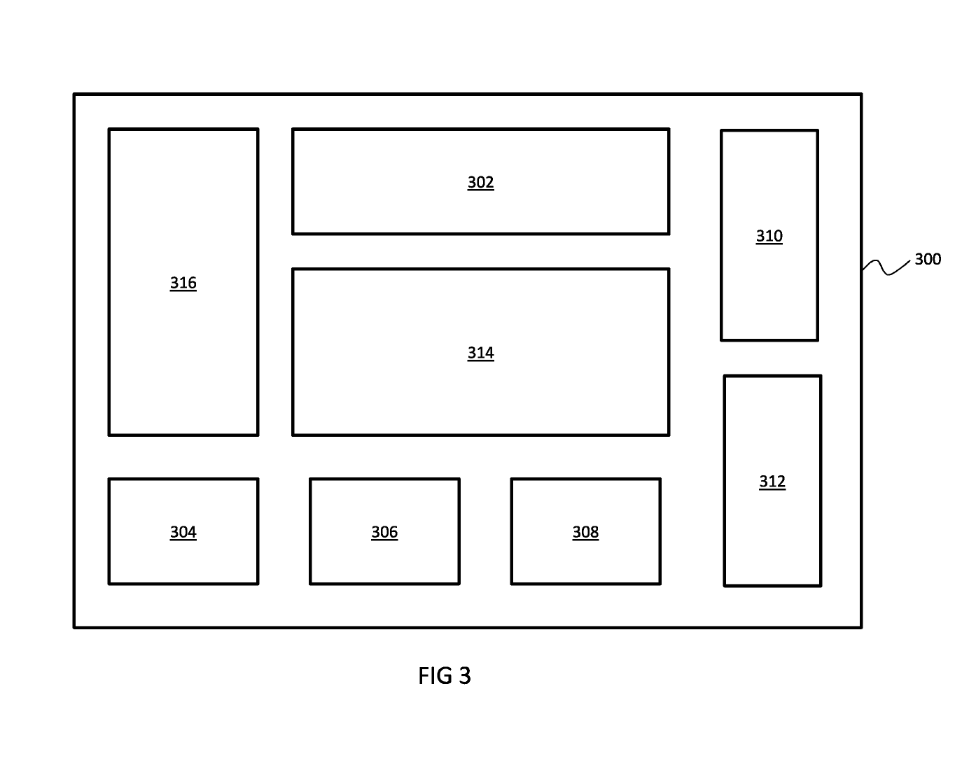

Referring now to FIG. 3, a schematic view of a financial transaction system 300 is depicted in accordance with an embodiment of the present invention.

The financial transaction system 300 includes a scanning module 302, an authorisation module 304, a transaction module 306, an encryption module 308, a first network interface module 310, a second network interface module 312, a processing module 314, and a user interface module 316.

All modules 302 through 314 in the financial transaction system 300 are logical modules and may be implemented using software, hardware, firmware, or any combination thereof. Additionally, one or more of these modules, may be implemented on a single device or a combination of different devices. For example, the scanning module 302 may be implemented as an independent handheld or mounted device adapted for scanning bar-code labels and sending price information to the authorisation module 304 located on another device at least insofar as a merchant is concerned.

The transaction module 306, first network interface module 310, the processing module 314, and the second network interface module 312 include all technical features of the transaction module 202, first network interface module 204, the processing module 206, and the second network interface module 208 respectively described in conjunction with FIG. 2. Wherever required, further technical features of these modules will be provided in the following description.

In an exemplary embodiment of the present invention, the financial transaction system 300 further includes a user interface module 316. In one example, the user interface module 316 is implemented on each of the devices 102 through 106.

Referring to the merchant-customer interaction during an in-store transaction, the merchant uses the user interface module 316 to input transaction price. In one example, the payee device 104 also includes the scanning module 302. As explained previously, the scanning module 302 may be implemented as an independent handheld or mounted device adapted for scanning bar-code labels. The merchant uses the scanning module 302 to scan a bar-code or the like corresponding to a product and service and the price information is transferred from the scanning module 302 to the authorisation module 304. The merchant may optionally manually input additional codes corresponding to goods/services being purchased by the customer. Once the price information has been fed to the authorisation module 304, the authorisation module 304 on the payee device 104 generates an authorisation request which includes payee digital token and transmits to the payer device 102.

The authorisation module 304 at the payer device receives the authorisation request. In one implementation, the authorisation module 304 triggers the user interface module 316 at the payer device 102 to prompt the customer to approve the authorisation module 304. The user interface module 316 thus generates a prompt message for the customer. The prompt message may, for example, show information about the merchant and the requested transaction amount and provide options to approve or reject the request. If rejected, the authorisation request reject message is then transmitted from the payer device 102 to the payee device 104 and the workflow is terminated.

In an alternative exemplary embodiment of the present invention, the transaction module 306 is configured to automatically approve the authorisation request based on one of a transaction value, the payee digital token, a geographical location of the payer device and/or payee device, and any combination thereof. Thus, the customer may pre-approve authorisation requests with transaction amount less than, say fifty US Dollars or may pre-approve authorisation requests from a particular merchant outlet, say a particular retail outlet or may use a combination of such criterion for pre-approval.

When the authorisation request is approved by the payer device 102, the payer device 102 packages payer digital token along with any other desired details such as payer cryptogram and transmits to the payee device 104. The payee device 104 then generates the transaction request.

In one example, the transaction request includes the payer digital token, the payee digital token, and at least one cryptogram uniquely identifying the transaction request originating from the payer device 102.

The cryptogram is generated using the encryption module 308. The encryption module 308 is configured for encrypting data transferred during at least one of intra-network and inter-network communication in and between the transactional network 110 and the payment network 120. In one exemplary embodiment, the encryption module 308 is implemented using a secure element implemented using a combination of hardware and firmware. The data encryption is performed using an encryption key shared between individual devices such as the payer device 102 residing within the transactional network 110 and one or more devices or entities residing within the payment network 120.

The cryptogram may include additional data to ensure that each transaction request originating from the payer device 102 is unique. Thus, the transaction request is not only uniquely traced back to the payer device 102 but also, each transaction request originating from the payer device 102 remains unique.

In an alternative implementation, the payer device 102 may itself generate the transaction request based on payee digital token and the transaction amount received as part of the authorisation request.

Once the transaction request has been generated, the payer device 102 and the payee device 104 assess network access parameters of each other to select a transaction mode whereby one device in the transactional network 110 is designated for transmitting the transaction request to the payment network 120.

In various exemplary embodiments of the present invention, four predefined transaction modes are available. The four modes are payer-online mode, payee-online mode, proxy-online mode, and offline mode.

As will now be readily understood, the transaction request is transmitted to the payment network 120 through payer device 102, payee device 104, and proxy device 106 in the payer-online mode, the payee-online mode, and the proxy-online mode respectively. When none of the payer, payee, and proxy devices are available to transmit the transaction request to the payment network 120, the offline mode is selected for carrying out the financial transaction.

The process of selecting a proxy device 106 through transmitting a routing request to successively to one or more proxy devices 106 in the vicinity of the payer device 102 and the payee device 104 and receiving a response to the routing request has already been explained previously.

When the financial transaction is carried out under offline mode, the transaction request is stored in each of the payer device 102 and the payee device 104 and subsequently, when either device connects to the payment network 120, the transaction request is transmitted thereto for further processing. In one example, the financial transaction system 200, 300 are configured to prompt a merchant when an offline mode is selected as the transaction mode for carrying out the financial transaction. The merchant may approve or reject. The financial transaction system 200, 300 may also be configured to pre-approve offline mode transaction based on certain criterion. For example, the payer digital token may correspond to the a pre-paid card or debit card and the information related to last updated time stamp and remaining funds in the card/account may be included in the payer digital token. The processing module 314 at the payee device 104 may be configured to approve an offline mode transaction if the relevant information satisfies certain predefined criterion. Such as time stamp of the last update should not be more than 24 hours old, the amount of funds should not be less than a certain value and so on.

The processing module 314 is configured for routing a transaction approval from the payment network 120 to the transaction module 306 resident at the payee device 104, whereupon the financial transaction between the payer device 102 and the payee device 104 is deemed completed. As will be appreciated that the designated device in the transactional network 110 interfaces with the payment network 120 and receives the transaction approval therefrom. The processing module 314 resident at the designated device then transmits the transaction approval through the communication channel 108 to the payee device 104 among others.

In an exemplary embodiment of the present invention, the processing modules 314 at the payer device 102 and the payee device 104 initiate a timer as soon as an authorisation request is received and generated respectively. In addition, the processing modules 314 keep track of the spatial distance between the payer device 102 and the payee device 104. The processing module 314 is further configured for generating a termination request based on one of spatial distance between the payer device 102 and the payee device 104 and/or and total time duration of the financial transaction exceeding respective predefined thresholds. For example, if the total time duration exceeds ten seconds and/or the spatial distance exceeds a certain threshold say, two meters, the termination requested is generated. The termination request is transmitted from the transactional network 110 to the payment network 120, whereupon the financial transaction is terminated.

As will now be apparent, several variations in the financial transaction system 300 described above are possible.

In an exemplary embodiment, the scanning module 302 resident on the payer device 102 may be used to directly scan products/services being purchased. The relevant information related to payee digital token may be available at multiple places within the retail store and the customer may use the scanning module 302 to retrieve that information. Alternatively, the processing module 314 resident on the payer device 102 may interface with the payee device 104 through the respective first network interface modules 310 over the communication channel 108 to retrieve the required information. The authorisation module 304 resident on the payer device 102 generates the authorisation request and subsequently, the transaction module 306 generates the transaction request. Alternatively, the required information may be communicated to the payee device 104, which may in turn, generate the transaction request. Subsequent processing of the transaction request may be handled in the manner described previously.

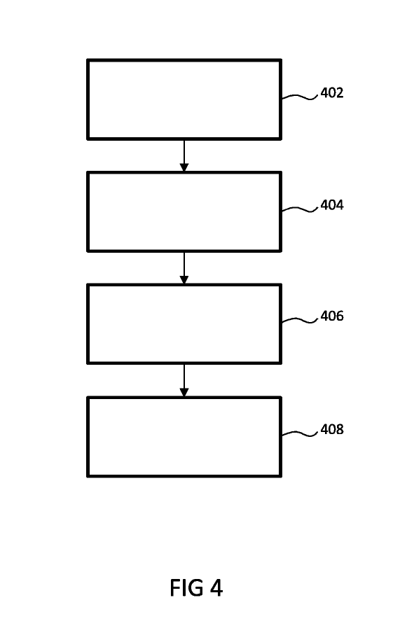

Referring now to FIG. 4, a flow-chart depicting a method for facilitating financial transactions is provided in accordance with an embodiment of the present invention.

The method depicted in the adjoining figure is intended to be practiced in the financial transaction network 100 as described in conjunction with FIG. 1.

Initially, at step 402, a transaction request is generated in response to an authorisation request for initiating the financial transaction.

Subsequently, at step 404, one or more network access parameters associated with at least the payer device 102 and the payee device 104 are determined. The network access parameters provide information related to access to the payment network 120 through the payer device 102 and the payee device 104.

Thereafter, at step 406, a transaction mode is set to one selected from a set of predefined transaction modes based on at least the network access parameters. Each predefined transaction mode designates at least one device 102, 104 in the transactional network 110 to route the transaction request from the transactional network to the payment network.

Finally, at step 408, the transaction request is transmitted to the payment network 120 through the designated device.

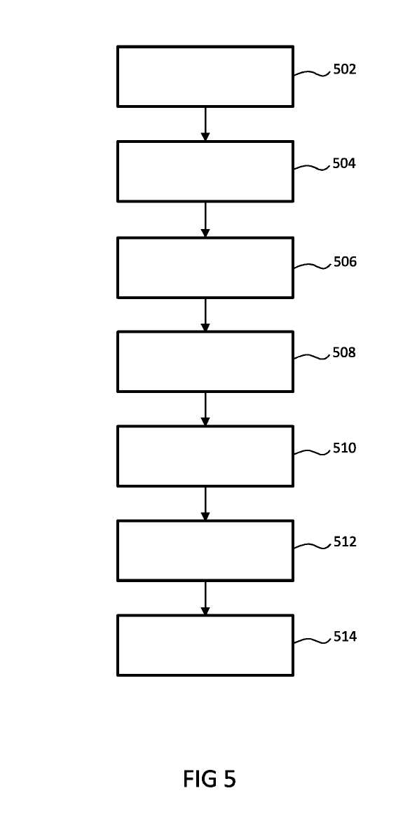

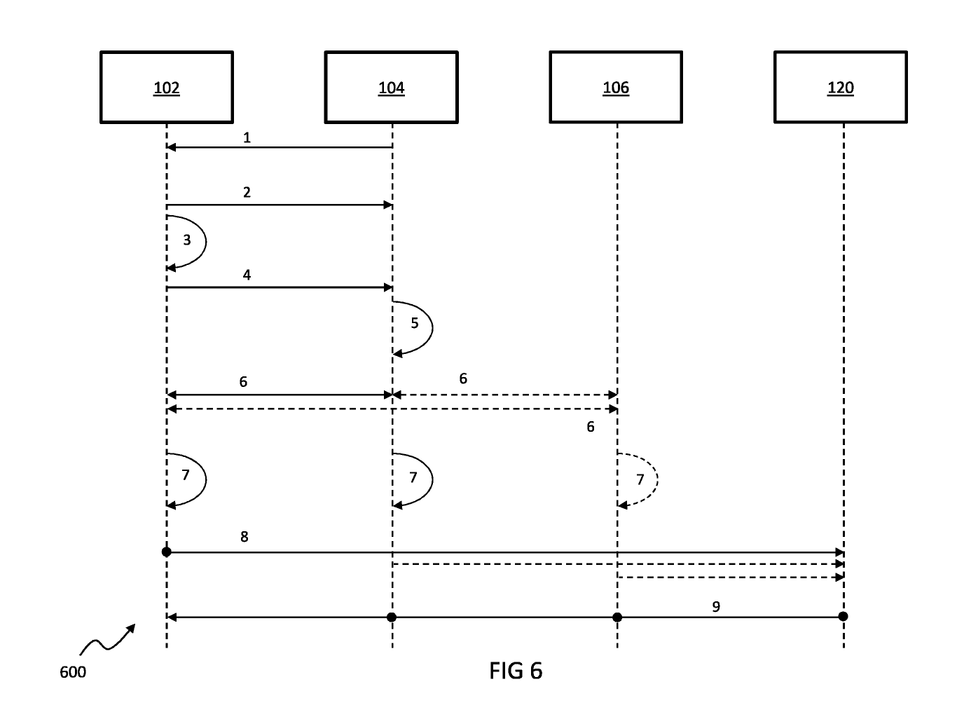

Referring now to FIGS. 5 and 6 together, a flowchart and a sequence diagram are shown. In particular, FIG. 5 depicts a method for facilitating financial transactions in accordance with an alternative embodiment of the present invention. FIG. 6 depicts a sequence diagram corresponding to a method for facilitating financial transactions in accordance with an embodiment of the present invention.

At step 502, the payee device 104 generates an authorisation request and transmits to the payer device 102 (Step 1).

In response, at step 504, the payer device 102 sends an approval in respect of the authorisation request to the payee device 104, (Step 2).

As described in detail, the authorisation by the customer may be handled in several different manners.

In one implementation, a user of the payer device is prompted to provide an approval for the authorisation request, wherein the transaction request is generated subsequent to receiving the approval from the user. In an alternative implementation, the authorisation request is automatically approved based on one of a transaction value, the payee digital token, a geographical location of the payer device and/or payee device, and any combination thereof.

The payer device 102 is also configured to provide payer digital token along with predefined additional information to the payee device 104. The information required to be transmitted, in part or in full, is encrypted (Step 3) before transmission (Step 4). Such data transfer from the payer device 102 to the payee device 104 may occur along with the approval to the authorisation request. The sequence of Steps 2 and 3 in FIG. 6 is thus interchanged accordingly. Steps 2 and Steps 4, in FIG. 6, are thus performed concurrently as a single step.

As evident from the above, according to the method of the present invention, the data transferred during at least one of intra-network and inter-network communication in and between the transactional network 110 and the payment network 120 is encrypted. The data encryption is performed using an encryption key shared between the payer device 102 residing within the transactional network 110 and one or more devices residing within the payment network 120.

At step 506, a transaction request is generated in response to an authorisation request for initiating the financial transaction (Step 5). FIG. 6 depicts that the transaction request is generated by the payee device 104. However, as previously explained, the transaction request may alternatively be generated by the payer device 102. Further, as explained in conjunction with preceding figures, the transaction request includes the payer digital token, the payee digital token, and optionally, at least one cryptogram uniquely identifying the transaction request originating from the payer device 102.

At step 508, one or more network access parameters associated with various devices present in the transactional network 110 are determined. The network access parameters provide information related to access to the payment network 120 the respective devices (Step 6).

At step 510, a transaction mode is set to one selected from a set of predefined transaction modes based on at least the network access parameters (Step 7). In various exemplary embodiments, criterion other than those based on network access parameters may be applied. For example, preferences based on role of the device (payer, payee, or proxy) may be configured and stored in the device.

Each predefined transaction mode designates at least one device in the transactional network 110 to route the transaction request from the transactional network 110 to the payment network 120.

The set of predefined transaction modes includes at least a payer-online mode and a payee-online mode. As previously explained, the transaction request is transmitted to the payment network 120 through the payer device 102 and the payee device 104 in the payer-online mode and the payee-online mode respectively.

As previously explained in detail, the transactional network 110 further includes one or more proxy devices 106. The proxy devices are adapted for routing the transaction request from the transactional network 110 to the payment network 120. Thus, in this embodiment, the set of predefined transaction modes further includes a proxy-online mode. In case neither the payer device 102 nor the payee device 104 has required data connectivity, a routing request is transmitted to at least one of the proxy devices 106. Thus, such routing request is transmitted based on the network access parameters associated with the payer device 102 and the payee device 104. The routing request is received at the proxy device 106, which in turn provides a response. The method steps related to identifying a proxy device 106 may be repeated until a proxy device 106 approves to act as proxy or all proxy devices have been scanned. The transaction mode is set to the proxy-online mode based on approval of the routing request, whereupon the transaction request is transmitted to the payment network through the proxy device.

In one exemplary embodiment, the set of predefined transaction modes further includes an offline mode. The transaction mode is set to the offline mode based on the network access parameters associated with the payer device 102 and the payee device 104, wherein the transaction request is stored in each of the payer device 102 and the payee device 104 and subsequently, transmitted to the payment network 120 when at least one of the payer device 102 and the payee device 104 acquires access to the payment network 120.

At step 512, the transaction request is transmitted to the payment network 120 through the designated device (Step 8). Subsequently, at step 514, a transaction approval status message is transmitted from the payment network 120 to the transactional network 110 (Step 9). In particular, the status message is provided to the designated device. The status message thus received is routed to other devices as may be desired. In particular, in case the payee device 104 is not the designated device, the status message is routed thereto. Thus, step 514 essentially involves routing the transaction approval from the payment network 120 to the payee device 104, whereupon the financial transaction between the payer device and the payee device is deemed completed.

In an exemplary embodiment of the present invention, a termination request is generated during any of the steps 502 through 512 based on one of spatial distance between the payer device 102 and the payee device 104 and/or total time duration of the financial transaction exceeding respective predefined thresholds, and transmitting the termination request from the transactional network 110 to the payment network 120, whereupon the financial transaction is terminated.

Thus, the techniques of present invention greatly facilitate a financial transaction between any two portable communication devices. Several advantages of the present invention will now be readily apparent from the description provided heretofore.

The key advantage of the present invention is to ensure that a mobile based payment transaction is successfully executed under various possible scenarios in respect of data connectivity on the payer and payee devices participating in the financial transaction.

The present invention can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk, Current examples of optical disks include compact disk-read only memory (CD-ROM), compact disk-read/write (CD-R/W) and DVD. Both processors and program code for implementing each aspect of the technology can be centralized or distributed (or a combination thereof) as known to those skilled in the art.

A data processing system suitable for storing a computer program product of the present technology and for executing the program code of the computer program product will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters can also be coupled to the system to enable the data processing system to become coupled to other data processing systems or remote printers or storage devices through intervening private or public networks. Modems, cable modem and Ethernet cards are just a few of the currently available types of network adapters. Such systems can be centralized or distributed, e.g., in peer-to-peer and client/server configurations. In some implementations, the data processing system is implemented using GPUs, FPGAs and ASICs.

While the present invention has been described in detail with reference to certain embodiments, it should be appreciated that the present invention is not limited to those embodiments. In view of the present disclosure, many modifications and variations would present themselves, to those of skill in the art without departing from the scope of various embodiments of the present invention, as described herein. The scope of the present invention is, therefore, indicated by the following claims rather than by the foregoing description. All changes, modifications, and variations coming within the meaning and range of equivalency of the claims are to be considered within their scope.

1. A method for facilitating a financial transaction in a transactional network, said transactional network comprising at least a payer device and a payee device, each device in said transactional network being communicatively interconnected, said payer device and said payee device being associated with a payer financial account and a payee financial account through a payer digital token and a payee digital token respectively, said transactional network adapted for interfacing with a payment network, said payment network adapted for executing a fund transfer from a payer financial account to a payee financial account, the method comprising:
generating a transaction request in response to an authorisation request for initiating said financial transaction,
determining one or more network access parameters associated with at least said payer device and said payee device, said network access parameters providing information related to access to said payment network through said payer and payee devices,
setting a transaction mode to one selected from a set of predefined transaction modes based on at least said network access parameters, wherein each predefined transaction mode designates at least one device in said transactional network to route said transaction request from said transactional network to said payment network, and
transmitting said transaction request to said payment network through said designated device.

2. The method according to claim 1 further comprising prompting a user to provide an approval for said authorisation request, wherein said transaction request is generated subsequent to receiving said approval from said user.

3. The method according to claim 1, wherein said authorisation request is automatically approved based on one of a transaction value, said payee digital token, a geographical location of said payer device and/or payee device, and any combination thereof.

4. The method according claim 1, wherein said transaction request comprises said payer digital token, said payee digital token, and at least one cryptogram uniquely identifying said transaction request originating from said payer device.

5. The method according to claim 1, wherein said set of predefined transaction modes comprises at least a payer-online mode and a payee-online mode, wherein said transaction request is transmitted to said payment network through said payer device and said payee device in said payer-online mode and said payee-online mode respectively.

6. The method according to claim 1, wherein said transactional network further comprises one or more proxy devices, said proxy devices being adapted for routing said transaction request from one of said payer device and said payee device to said payment network, and wherein said set of predefined transaction modes further comprises a proxy-online mode, and wherein the method further comprises:
transmitting a routing request to at least one of said proxy devices based on said network access parameters associated with said payer device and said payee device; and
receiving a response to said routing request, wherein said transaction mode is set to said proxy-online mode based on approval of said routing request, whereupon said transaction request is transmitted to said payment network through said proxy device.

7. The method according to claim 1, wherein said set of predefined transaction modes further comprises an offline mode, and wherein said transaction mode is set to said offline mode based on said network access parameters associated with said payer device and said payee device, wherein said transaction request is stored in each of said payer device and said payee device and subsequently, transmitted to said payment network when at least one of said payer device and said payee device acquires access to said payment network.

8. The method according to claim 1 further comprising routing a transaction approval from said payment network to said payee device, whereupon said financial transaction between said payer device and said payee device is deemed completed.

9. The method according to claim 1 further comprising generating a termination request based on one of spatial distance between said payer and payee devices and/or total time duration of said financial transaction exceeding respective predefined thresholds, and transmitting said termination request from said transactional network to said payment network, whereupon said financial transaction is terminated.

10. The method according to claim 1, wherein data transferred during at least one of intra-network and inter-network communication in and between said transactional network and said payment network is encrypted, wherein data encryption is performed using an encryption key shared between said payer device residing within said transactional network and one or more devices residing within said payment network.

11. A system for facilitating a financial transaction in a transactional network, said transactional network comprising at least a payer device and a payee device, each device in said transactional network being communicatively interconnected, said payer device and said payee device being associated with a payer financial account and a payee financial account through a payer digital token and a payee digital token respectively, said transactional network adapted for interfacing with a payment network, said payment network adapted for executing a fund transfer from a payer financial account to a payee financial account, the system comprising:
a transaction module, said transaction module configured for generating a transaction request in response to an authorisation request for initiating said financial transaction,
a first network interface module, said first network interface module configured for determining one or more network access parameters associated with at least said payer device and said payee device, said network access parameters providing information related to access to said payment network through said payer and payee devices,
a processing module, said processing module configured for setting a transaction mode to one selected from a set of predefined transaction modes based on at least said network access parameters, wherein each predefined transaction mode designates at least one device in said transactional network to route said transaction request from said transactional network to said payment network, and
a second network interface module, said second network interface module configured for transmitting said transaction request to said payment network through said designated device.

12. The system according to claim 11 further comprising a user interface module resident on said payer device, said user interface module configured for prompting a user to provide an approval for said authorisation request, wherein said transaction module is configured to generate said transaction request subsequent to receiving said approval from said user.

13. The system according to claim 11, wherein said transaction module is configured to automatically approve said authorisation request based on one of a transaction value, said payee digital token, a geographical location of said payer device and/or payee device, and any combination thereof.

14. The system according to claim 1, wherein said transaction request comprises said payer digital token, said payee digital token, and at least one cryptogram uniquely identifying said transaction request originating from said payer device.

15. The system according to claim 11, wherein said set of predefined transaction modes comprises at least a payer-online mode and a payee-online mode, wherein said transaction request is transmitted to said payment network through said payer device and said payee device in said payer-online mode and said payee-online mode respectively.

16. The system according to claim 11, wherein said transactional network further comprises one or more proxy devices, said proxy devices being adapted for routing said transaction request from one of said payer device and said payee device to said payment network, and wherein said set of predefined transaction modes further comprises a proxy-online mode, and wherein said processing module is configured for
transmitting a routing request to at least one of said proxy devices based on said network access parameters associated with said payer device and said payee device; and
receiving a response to said routing request, wherein said processing module sets said transaction mode to said proxy-online mode based on approval of said routing request, whereupon said transaction request is transmitted to said payment network through said proxy device.

17. The system according to claim 11, wherein said set of predefined transaction modes further comprises an offline mode, and wherein said transaction module is configured for setting said transaction mode to said offline mode based on said network access parameters associated with said payer device and said payee device, whereupon said transaction request is stored in each of said payer device and said payee device and subsequently, transmitted to said payment network when at least one of said payer device and said payee device acquires access to said payment network.

18. The system according to claim 11, wherein said processing module is further configured for routing a transaction approval from said payment network to said transaction module resident at said payee device, whereupon said financial transaction between said payer device and said payee device is deemed completed.

19. The system according to claim 11 further comprising said processing module is further configured for generating a termination request based on one of spatial distance between said payer and payee devices and/or total time duration of said financial transaction exceeding respective predefined thresholds, wherein said termination request is transmitted from said transactional network to said payment network, whereupon said financial transaction is terminated.

20. The system according to claim 11 further comprising an encryption module, said encryption module configured for encrypting data transferred during at least one of intra-network and inter-network communication in and between said transactional network and said payment network, wherein data encryption is performed using an encryption key shared between said payer device residing within said transactional network and one or more devices residing within said payment network.

21. A computer program product embodied on a non-transitory computer readable medium, said computer-readable medium comprising computer-executable instructions executable by a processor for facilitating a financial transaction in a transactional network, said transactional network comprising at least a payer device and a payee device, each device in said transactional network being communicatively interconnected, said payer device and said payee device being associated with a payer financial account and a payee financial account through a payer digital token and a payee digital token respectively, said transactional network adapted for interfacing with a payment network, said payment network adapted for executing a fund transfer from a payer financial account to a payee financial account, said computer-executable instructions comprising:
program instructions for causing said processor to generate a transaction request in response to an authorisation request for initiating said financial transaction,
program instructions for causing said processor to determine one or more network access parameters associated with at least said payer device and said payee device, said network access parameters providing information related to access to said payment network through said payer and payee devices,
program instructions for causing said processor to set a transaction mode to one selected from a set of predefined transaction modes based on at least said network access parameters, wherein each predefined transaction mode designates at least one device in said transactional network to route said transaction request from said transactional network to said payment network, and
program instructions for causing said processor to transmit said transaction request to said payment network through said designated device.

22. The computer program product according to claim 21 further comprising program instructions for causing said processor to prompt a user to provide an approval for said authorisation request, wherein said transaction request is generated subsequent to receiving said approval from said user.

23. The computer program product according to claim 21, wherein said authorisation request is automatically approved based on one of a transaction value, said payee digital token, a geographical location of said payer device and/or payee device, and any combination thereof.

24. The computer program product according to claim 21, wherein said transaction request comprises said payer digital token, said payee digital token, and at least one cryptogram uniquely identifying said transaction request originating from said payer device.

25. The computer program product according to claim 21, wherein said set of predefined transaction modes comprises at least a payer-online mode and a payee-online mode, wherein said transaction request is transmitted to said payment network through said payer device and said payee device in said payer-online mode and said payee-online mode respectively.

26. The computer program product according to claim 21, wherein said transactional network further comprises one or more proxy devices, said proxy devices being adapted for routing said transaction request from one of said payer device and said payee device to said payment network, and wherein said set of predefined transaction modes further comprises a proxy-online mode, and wherein the computer program product further comprises:
program instructions for causing said processor to transmit a routing request to at least one of said proxy devices based on said network access parameters associated with said payer device and said payee device; and
program instructions for causing said processor to receive a response to said routing request,
wherein said transaction mode is set to said proxy-online mode based on approval of said routing request, whereupon said transaction request is transmitted to said payment network through said proxy device.

27. The computer program product according to claim 21, wherein said set of predefined transaction modes further comprises an offline mode, and wherein said transaction mode is set to said offline mode based on said network access parameters associated with said payer device and said payee device, wherein said transaction request is stored in each of said payer device and said payee device and subsequently, transmitted to said payment network when at least one of said payer device and said payee device acquires access to said payment network.

28. The computer program product according to claim 21 further comprising program instructions for causing said processor to route a transaction approval from said payment network to said payee device, whereupon said financial transaction between said payer device and said payee device is deemed completed.

29. The computer program product according to claim 21 further comprising program instructions for causing said processor to generate a termination request based on one of spatial distance between said payer and payee devices and/or total time duration of said financial transaction exceeding respective predefined thresholds, and program instructions for causing said processor to transmit said termination request from said transactional network to said payment network, whereupon said financial transaction is terminated.

30. The computer program product according to claim 21, wherein data transferred during at least one of intra-network and inter-network communication in and between said transactional network and said payment network is encrypted, wherein data encryption is performed using an encryption key shared between said payer device residing within said transactional network and one or more devices residing within said payment network.
